(19) United States
(12) Patent Application Publication
(10) Pub. No.: US 2013/0315226 A1
(43) Pub. Date: Nov. 28, 2013

(54) TIME SYNCHRONISATION IN A SINGLE NETWORK

(71) Applicant: Carlo Bombelli, Roncadelle (IT)

(72) Inventor: Carlo Bombelli, Roncadelle (IT)

(73) Assignee: ONETASTIC S.R.L., Brescia (BS) (IT)

(21) Appl. No.: 13/984,774

(22) PCT Filed: Feb. 16, 2012
(86) PCT No.: PCT/IB12/50707

§ 371 Date: Aug. 9, 2013

(30) Foreign Application Priority Data
Feb. 18, 2011 (IT) TO2011A000141

(51) Int. Cl. H04W 56/00

(52) U.S. Cl. CPC H04W 56/0015
USPC 370/350

(57) ABSTRACT

A method for synchronizing in time a plurality of transmitters (T1-T7) belonging to a single frequency network, the transmitters (T1-T7) being adapted to distribute a radio frequency signal over a territory, includes: identifying, for each transmitter of the plurality of transmitters (T1-T7), at least two transmitters (T1-T5; T6,T7) whose catchment area (B1-B7) includes at least one common catchment area (B12,B23,B34,B45; B67), and associating the at least two transmitters (T1-T5; T6,T7) with a subset of transmitters (S1; S2); identifying, within the subset of transmitters (S1; S2), one reference transmitter (TX) and at least one secondary transmitter (TS); determining, for each secondary transmitter (TS), a respective time offset with respect to the reference transmitter (TX) on the basis of time references contained in the radio frequency signal transmitted by the reference transmitter (TX) and received by the secondary transmitter (TS); adjusting the transmission parameters of the secondary transmitter (TS) so as to keep the time offset constant.

The present invention relates to a method for synchronizing in time a plurality of transmitters belonging to a single frequency network.

More in particular, the present invention relates to a method for synchronizing in time a plurality of transmitters belonging to a single frequency network, wherein the transmitters are adapted to distribute a radio frequency signal over a territory, in particular a digital terrestrial television signal.

Transmission networks for digital terrestrial television signals may operate, as is the case in Italy, in “SFN” mode, i.e. in a single frequency network.

If a certain geographic area, e.g. Lombardy, cannot be totally served by using a single transmitter, additional transmitters are installed in order to provide signal coverage in those areas which are not reached by the signal of the main transmitter.

To better exploit the available frequency resources, all transmitters irradiate the same signal on the very same frequency. In this way, however, in those portions of territory where the signal from more than one transmitter can be received, the receiving antenna may receive (at a given frequency or, likewise, on a particular channel) a main signal and one or more interfering signals from multiple transmitters.

Unlike the analog television signal, the digital terrestrial system can withstand this interference, provided that the various transmitters are synchronized with one another according to very strict rules regarding both time and frequency.

When a broadcasting network using the “SFN” technique is defined, a time offset, or delay, is determined univocally for each transmitter, at which each transmitter in the network must constantly operate. This parameter can be modified only through external intervention of the network operator.

The SFN networks known in the art utilize an external synchronism signal supplied by a GPS (“Global Positioning System”) receiver for the purpose of keeping all network transmitters synchronized in terms of both frequency and time. Other solutions use, as an external synchronism signal, control signals sent over a LAN network, or a common reference broadcast via satellite.

The external synchronism signal, e.g. the GPS signal, can be univocally received equal to itself over the entire national territory, and can synchronize the frequency of and provide a time reference to all transmitters belonging to the same network.

However, the method currently in use for synchronizing the transmitters of an SFN network has many drawbacks.

In the first place, for the entire signal broadcasting network to operate properly it is necessary to install external devices, i.e. GPS receivers, the technology of which is different from the one employed for those transmitters which are not integrated with the systems themselves, so that reliability problems may arise.

In the second place, the proper operation of the entire signal broadcasting network depends on the availability of the external reference: if the latter is lost, e.g. due to failures or adverse weather conditions, the entire signal broadcasting network may become completely inoperative.

In the third place, when a third-party satellite system is used as an absolute reference source, such as the GPS system currently in use for most installations, the proper operation of the entire broadcasting network depends on parameters out of the network operator's control. In fact, it is known that the use of the GPS system, or of similar satellite reception systems, is free: however, it is not possible to enter into service contracts to ensure continuity of service or adequate performance levels. In other words, the GPS system is offered “as is”, and may suddenly become inadequate or technically insufficient at any time, without the network operator being allowed to do anything or to raise any objection.

Finally, alternative solutions are also available which can be managed directly by network operators, but the necessary infrastructure is at present very costly and complex, and therefore cannot be practically implemented to advantage.

It is therefore an object of the present invention to provide a method for synchronizing in time a plurality of transmitters belonging to a single frequency network which allows the network operator to control the time synchronization of said transmitters autonomously, i.e. without depending upon any third parties.

It is a further object of the present invention to provide a method for synchronizing in time a plurality of transmitters belonging to a single frequency network which does not use an external synchronism signal supplied by a satellite.

It is a further object of the present invention to provide a method for synchronizing in time a plurality of transmitters belonging to a single frequency network which is highly reliable.

It is a further object of the present invention to provide a method for synchronizing in time a plurality of transmitters belonging to a single frequency network which can be easily implemented and at low cost.

These and other objects of the invention are achieved through a method for synchronizing in time a plurality of transmitters belonging to a single frequency network as claimed in the appended claims, which are an integral part of the present description.

The invention also relates to a system implementing a method according to the present invention, and to a network of transmitters which comprises said system.

In brief, the method according to the invention introduces, in the method for synchronizing in time a plurality of transmitters belonging to a single frequency network, the concept of relative synchronism, as opposed to the prior-art concept of absolute synchronism, i.e. rigidly synchronizing all network transmitters with the same absolute reference.

The method according to the invention, in fact, subdivides the set of transmitters of the network into subsets of transmitters, wherein one reference transmitter and one or more secondary transmitters are identified for each given area of the broadcasting network. The synchronism of a secondary transmitter is referred, whether directly or indirectly, to the reference transmitter, thus making it unnecessary to use absolute synchronism.

Further features of the invention are set out in the appended claims, which are intended as an integral part of the present description.

The above objects will become more apparent from the following detailed description of the method for synchronizing in time a plurality of transmitters belonging to a single frequency network, with particular reference to the annexed drawings, wherein:

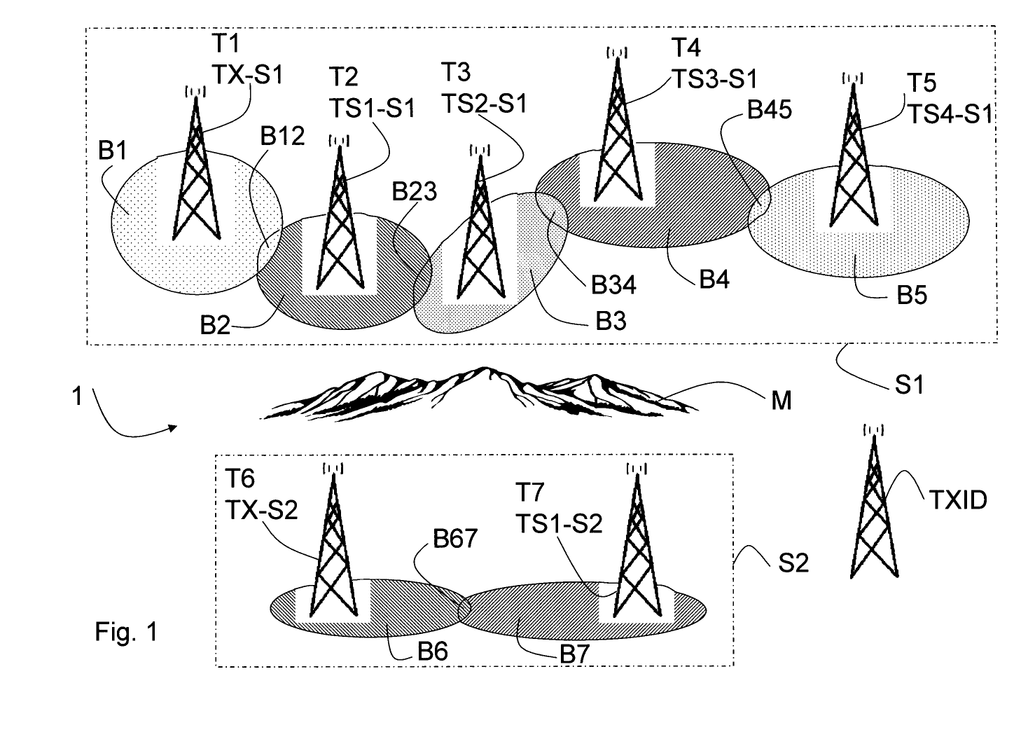

FIG. 1 is a diagram of a single frequency network comprising a plurality of transmitters;

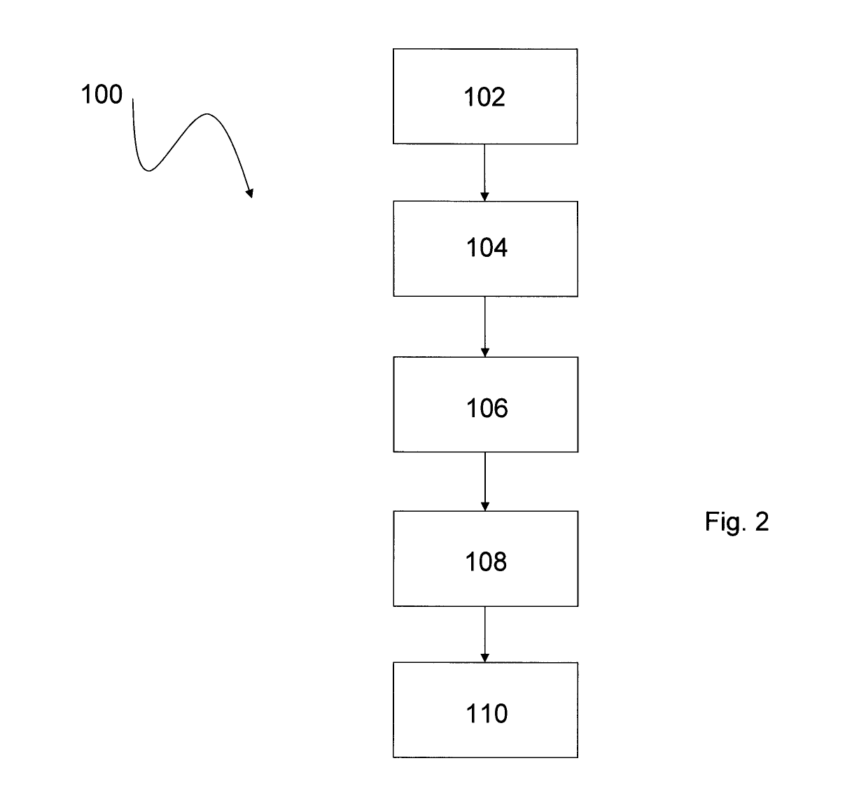

FIG. 2 is a flow chart of a method for synchronizing in time a plurality of transmitters belonging to a single frequency network according to the invention. With reference to FIG. 1, there is shown a diagram of a single frequency network 1 comprising a plurality of transmitters T1-T7.

The transmitters T1-T7 are adapted to distribute a radio frequency signal, in particular a digital terrestrial television signal, over a territory covered by the single frequency network 1. The digital terrestrial television signal typically originates from a broadcasting control room (not shown).

With reference to FIG. 2, there is shown a flow chart 100 of a method for synchronizing in time the plurality of transmitters T1-T7 belonging to the single frequency network 1.

At step 102 it is determined, in a univocal manner and for each transmitter T1-T7, the time offset, or delay, at which each transmitter T1-T7 of the network must constantly operate in order to allow the network 1 to operate as a single frequency network. Said time offset is the time required by the radio frequency signal to travel from the broadcasting control room to each one of the transmitters T1-T7 operating in the single frequency network 1. This is a constant time which is a function of the specific network architecture, and does not depend on external factors. A so-called intentional delay is also determined, which is necessary for optimizing reception within a service area common to two or more network transmitters.

At step 104 the network 1 is analyzed, and for each transmitter T1-T7 of the single frequency network 1 a subset S1,S2 of the transmitters T1-T7 is identified which can be superimposed, in at least one populated point of the territory covered by the radio frequency signal, on that of another transmitter T1-T7.

By way of example, and still with reference to FIG. 1, each transmitter T1-T7 has a respective catchment area, or signal coverage area, B1-B7. It can be observed that the transmitters T1 and T2 have a common catchment area B12, the transmitters T2 and T3 have a common catchment area B23, the transmitters T3 and T4 have a common catchment area B34, and the transmitters T4 and T5 have a common catchment area B45.

Since the transmitters T1-T5 are correlated with one another like a chain, they are associated with a same subset S1 of transmitters.

The transmitters T6 and T7 do not belong to the subset S1 because, there being an obstacle M between them, e.g. a mountain, there is no common catchment area between one of the transmitters T1-T5 and one of the transmitters T6-T7. However, the transmitters T6 and T7 have a respective catchment area B6,B7 that defines a common catchment area B67. Therefore, according to the above logic, the transmitters T6 and T7 belong to a subset S2 of transmitters.

The method then goes on to step 106, wherein a criterion of interdependency is established between the transmitters T1-T7 belonging to a given subset S1,S2, and one reference transmitter TX and at least one secondary transmitter TS are identified within each subset S1,S2.

At step 108, a priority criterion is further established between the secondary transmitters TS of a given subset S1,S2 by determining the time offset between one secondary transmitter TS and the reference transmitter TX, i.e. the time required by the radio frequency signal to travel from the reference transmitter TX to the secondary transmitter TS. If the secondary transmitter TS is not in view with respect to the main transmitter TX, the time offset is referred to another secondary transmitter TS. Said priority criterion thus allows to define a tree structure in which each secondary transmitter TS, as previously defined, has a time offset calculated directly with respect to the reference transmitter TX, if the two transmitters TX,TS are in view, or indirectly, if the two transmitters TX,TS are not in view.

For example, let us assume, with reference to FIG. 1, that the transmitter T1 is selected as a main transmitter TX-S1 for the subset S1. The transmitter T2 is assigned the role as first secondary transmitter TS1-S1, the transmitter T3 is assigned the role as second secondary transmitter TS2-S1, the transmitter T4 is assigned the role as third secondary transmitter TS3-S1, and the transmitter T5 is assigned the role as fourth secondary transmitter TS4-S1.

Likewise, within the subset S2 the transmitter T6 is identified as a main transmitter TX-S2, whereas the transmitter T7 is assigned the role as first secondary transmitter TS1-S2.

It should be noted that the choice of the main transmitter TX within a subset S is merely aimed at optimizing the tree of dependencies among the various transmitters TX,TS, and is not related to any physical parameter of the radio frequency signal.

Step 110 calculates, for each subset S, the time offset of the secondary transmitter TS with the highest priority with respect to the reference transmitter TX, then the time offset of the secondary transmitter TS with the next lower priority with respect to the reference transmitter TX, if the latter is in view, or with respect to the secondary transmitter TS with the next higher priority, if the reference transmitter TX is not in view.

For example, within the subset S1 it is calculated the time offset of the first secondary transmitter TS1-S1 with respect to the reference transmitter TX-S1; then the time offset of the second secondary transmitter TS2-S1 with respect to the first secondary transmitter TS1-S1, since the main transmitter is not in view, and so forth for the other secondary transmitters TS3-S1 and TS4-S1.

Likewise, within the subset S2 the time offset of the secondary transmitter TS1-S2 is calculated with respect to the reference transmitter TX-S2.

In this manner, each transmitter T1-T7 belongs to a specific subset S1,S2 of transmitters, and for each transmitter T1-T7 a respective time offset is determined, whether directly or indirectly, with respect to a reference transmitter TX.

At this point, in order to ensure that the transmitters T1-T7 belonging to the single frequency network 1 are synchronized in time, it is sufficient to install, at each secondary transmitter TS, means adapted to receive the radio frequency signal emitted by the reference transmitter TX, which, by correlating the signal emitted by the secondary transmitter TS concerned with the signal emitted by the reference transmitter TX (with particular reference to the time indicators contained in the signal itself), can determine at any instant the time offset between the transmitter TS concerned and the reference transmitter TX, and thus adjust the transmission parameters of the secondary transmitter TS accordingly, so as to keep absolutely constant the time offset with respect to the reference transmitter TX.

As an alternative, if it is impossible to receive the emitted signal, e.g. the signal corresponding to the service called “RaiUno”, at the installation site of the secondary transmitter TS concerned neither from the reference transmitter TX nor from any other secondary transmitter TS belonging to the same subset, but it is possible to receive the signal broadcast by any other indirect reference transmitter TXID broadcasting signals, e.g. corresponding to the service called “Canale 5”, in the same standard (or anyway in a standard that allows defining an adequate time base), the method according to the present invention can be implemented by: calculating in advance the desired time offset between the secondary transmitter TS concerned and the indirect reference transmitter TXID; installing, at the secondary transmitter TS, means adapted to receive the signal of said indirect reference transmitter TXID; demodulating the signal received from the indirect reference transmitter TXID, reconstructing on the basis of the time references contained in said signal the absolute time used by the transmitter for irradiating the signal; and, finally, using said information to keep constant over time the synchronization of the secondary transmitter TS concerned with respect to the indirect reference transmitter TXID. For example, with reference to signals complying with the DVB-T standard, by using the information contained in the MIP (“Megaframe Initialization Packet”) of the received signal, it is possible to determine the megaframe start time instant with respect to the last time reference received, which will allow to reconstruct the absolute time. If the transmitter is locked to a GPS, said time reference will be the last PPS (“Pulse Per Second”) signal received, which, together with the megaframe duration (information contained in the MIP), will allow to reconstruct the absolute time. Of course, those secondary transmitters TS which cannot see directly (in the electromagnetic sense) the reference transmitter TX are nonetheless capable of keeping absolutely constant the time offset with respect to the secondary transmitter TS with higher priority as described above. In a variant of the method according to the invention, it is possible to define more than one reference transmitter TX within a given subset S, so as to attain redundant system control and more control over the single frequency network 1.

Frequency synchronism between the secondary transmitters TS and the reference transmitter TX is ensured by suitable devices.

The features of the present invention, as well as the advantages thereof, are apparent from the above description.

A first advantage of the present method for synchronizing a plurality of transmitters belonging to a single frequency network is that transmitter synchronism is not bound to any external reference signal, in particular a GPS system. Thanks to the particular subdivision into subsets of the transmitters belonging to a given single frequency network according to the present invention, it is possible to establish relative synchronism among the various transmitters, so that the network can be operated in an extremely reliable way.

A second advantage of the method according to the present invention is its low cost of implementation, since it requires no special infrastructures, save for the application of a device that ensures a constant time offset between two transmitters.

A third advantage of the method according to the present invention is that said method implements a sort of feedback loop which dynamically verifies, at any time instant, that the time offset at which the various transmitters must operate is constant over time, and possibly corrects said offset in the event of any drift thereof.

The method for synchronizing in time a plurality of transmitters belonging to a single frequency network described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to a method for synchronizing in time a plurality of transmitters belonging to a single frequency network, but may be subject to many modifications, improvements or replacements of equivalent parts and elements without departing from the inventive idea, as clearly specified in the following claims.

1. A method for synchronizing in time a plurality of transmitters (T1-T7) belonging to a single frequency network, said transmitters (T1-T7) being adapted to distribute a radio frequency signal over a territory, comprising the steps of:
identifying, for each transmitter of said plurality of transmitters (T1-T7), at least two transmitters (T1-T5; T6,T7) whose catchment area (B1-B7) includes at least one common catchment area (B12,B23,B34,B45; B67), and associating said at least two transmitters (T1-T5; T6,T7) with a subset of transmitters (S1; S2);
identifying, within said subset of transmitters (S1; S2), one reference transmitter (TX) and at least one secondary transmitter (TS);
determining, for each secondary transmitter (TS), a respective time offset with respect to said reference transmitter (TX) on the basis of time references contained in said radio frequency signal transmitted by said reference transmitter (TX) and received by said secondary transmitter (TS); and
adjusting the transmission parameters of said secondary transmitter (TS) so as to keep said time offset constant.

2. A method according to claim 1, wherein said at least one secondary transmitter (TS) comprises two or more secondary transmitters (TS1-S1,TS2-S1,TS3-S1,TS4-S1; TS1-S2) arranged in accordance with a priority criterion.

3. A method according to claim 2, wherein said time offset between said secondary transmitter (TS) and said reference transmitter (TX) is directly referred to said reference transmitter (TX), if said secondary transmitter (TS1-S1; TS1-S2) and said reference transmitter (TX-S1; TX-S2) are in view; otherwise, said time offset between said secondary transmitter (TS2-S1,TS3-S1,TS4-S1) and said reference transmitter (TX-S1; TX-S2) is obtained through a time offset between said secondary transmitter (TS2-S1,TS3-S1,TS4-S1) and another secondary transmitter (TS1-S1,TS2-S1,TS3-S1) based on said priority criterion.

4. A method according to claim 2, wherein said reference transmitter (TX) is selected within said subset of transmitters (S1; S2) so as to optimize said priority criterion between said reference transmitter (TX) and said at least one secondary transmitter (TS).

5. A method according to claim 1, wherein said subset of transmitters (S1,S2) comprises more than one reference transmitter (TX).

6. A method according to claim 1, wherein said time offset takes into account the respective time offset required by said radio frequency signal to travel to each transmitter (T1-T7) from a control room broadcasting said radio frequency signal.

7. A method according to claim 1, wherein each transmitter (T1-T7) belongs to only one subset (S1; S2) of transmitters.

8. A method according to claim 1, wherein said reference transmitter (TXID) does not belong to any of said subsets (S1,S2) of transmitters and transmits said radio frequency signal in a transmission standard that allows to extrapolate information from said signal which allows to define a time base for said plurality of transmitters (T1-T7).

9. A method according to claim 1, wherein said single frequency network is a network adapted to broadcast a digital terrestrial television signal.

10. A method according to claim 8, wherein said time references are included in a MIP packet of said digital terrestrial television signal.

11. A system for synchronizing in time a plurality of transmitters (T1-T7) belonging to a single frequency network (1) and adapted to distribute a radio frequency signal over a territory, wherein said system comprises means for implementing the method according to claim 1.

12. A single frequency network comprising a system as claimed in claim 11.
